(19) United States
(12) Patent Application Publication
(10) Pub. No.: US 2014/0028046 A1
(43) Pub. Date: Jan. 30, 2014

(54) Tailgate adjustable ex support and stable cable systems

(71) Applicants: Glenn Cauley Cauley, West Mifflin, PA (US); Michelle Ann Gwynn, South Park, PA (US)

(72) Inventors: Glenn Cauley Cauley, West Mifflin, PA (US); Michelle Ann Gwynn, South Park, PA (US)

(21) Appl. No.: 13/470,545

(22) Filed: May 14, 2012

(51) Int. Cl. B62D 33/027

(52) U.S. Cl. CPC B62D 33/0273
USPC 296/57.1

(57) ABSTRACT

The Tailgate Adjustable EX Support and Stable Cable Systems, will provide the pickup truck owner extra tailgate support while loading and unloading cargo. (examples are lawn and landscape equipment, construction material and recreational vehicles, such as motorcycles, ATV'S, UTV'S and more.) The Tailgate Adjustable EX Support and Stable Sable Systems is easy to install by simply using the latching system already in place on your pickup truck tailgate. Once the Tailgate Adjustable EX Support and Stable Cable Systems is in place you can use the adjustable ratchet to tighten the straps in the position needed. With a variety of makes and models we have assorted styles to fit every need for the pickup truck owner. The Stable Cable is used for those who need to hold the tailgate in the full open only position only for extra support.

### TECHNICAL FIELD OF INVENTION

The invention relates to a Tailgate Adjustable EX Support and Stable Cable Systems particularly for pickup trucks. The Tailgate Adjustable EX Support and Stable Cable Systems is a completely assembled structure using woven nylon fabric straps, ratcheting products slip hooks and cables already manufactured.

The Keyhole, Pin, Angle latch and Open pin made with metal plates add to complete the system. Stable Cable System uses the same end 1 and end 2 pin, angle latch, open pin, keyhole, slip hook. To install into the latching system already in place of the tailgate from the manufacture of pickup trucks including but not limited to size, length and material make up. The Tailgate Adjustable EX Support and Stable Cable System is a support system for the pickup truck owner so that you can support your tailgate in confidence that with the tailgate adjustable EX support and stable cable system you will need when loading and unloading heavy cargo such as lawn and landscape equipment, construction tools and material, ATV'S, UTV'S, tractors, motorcycles and more.

### SUMMARY OF THE INVENTION

Many pickup truck owners put a load on their tailgate taking the chance of not knowing the true integrity of their “OEM” installed cables. The pickup truck consumer has established a demand for the Tailgate Adjustable EX Support and Stable Cable Systems that can be easily installed and easily removed. By using the“OEM” latching system in place, this can be accomplished. The primary use of the Tailgate Adjustable EX Support and Cable Systems are (1) Extra support for your tailgate while loading and unloading heavy cargo into the pickup truck bed, such as lawn and landscape equipment, construction tools and material, recreational vehicles like ATV'S, UTV'S, Riding Tractors, motorcycles and more. (2) By using the Tailgate Adjustable EX Support and Stable Cable System you can adjust the tailgate to several positions by using the ratchet system as needed when your product or cargo extends past the length of original pickup truck bed, your tailgate can tilt out making it easier to have that extra room needed. (3) Using the Stable Cable System is just another way to give your tailgate the extra support in the open position without adjusting.

### BACKGROUND OF THE INVENTION

The Tailgate Adjustable EX Support and Stable Cable System was invented due to poor integrity of “OEM” tailgate cables.

Tailgate Adjustable EX Support and Stable Cable Systems is for the pickup truck owner to install and use while loading and unloading heavy cargo such as lawn and landscape equipment, construction materials, motorcycles, ATV'S, UTV'S, and more.

The option to adjust the pickup truck tailgate to an angled position, while securing objects that extend beyond pickup truck bed. Pickup truck owners will be able to load and unload heavy cargo such as lawn and landscape equipment, construction materials and recreational vehicles. The Tailgate Adjustable EX Support and Stable Cable System gives the pickup truck owner the EX support their tailgate needs in the open position only.

Disclosing Patent # 6 279 979 B1 Tailgate Support is our invention and this is a new style Due to demand of customers.

### BRIEF DESCRIPTION OF THE DRAWINGS

The tailgate adjustable EX support stable cable system invention will be more fully described, by way of example, with in reference to the drawings.

FIGS. 1, 2 and 3) is a perspective view of the angle latch end 1) and slip hook end 2) assembly. Pin end 1) and keyhole end 2) assembly. Open pin end 1) and keyhole end 2) assembly according to the invention.

FIG. 4) is a full view of the installed adjustable system according to the invention.

FIG. 5) is a full view of the adjustable system showing multiple angles as they use the adjustable ratcheting system according to the invention.

FIG. 6) is a view of the angle latch end 1) and slip hook as a cable system according to the invention.

FIG. 7) is a view of the pin end 1) and keyhole end 2) as a cable system according to the invention.

FIG. 8) is a view of the open pin end 1) and keyhole end 2) as a cable system according to the invention.

FIG. 9) is a view of the stable cable system installed in an open position.

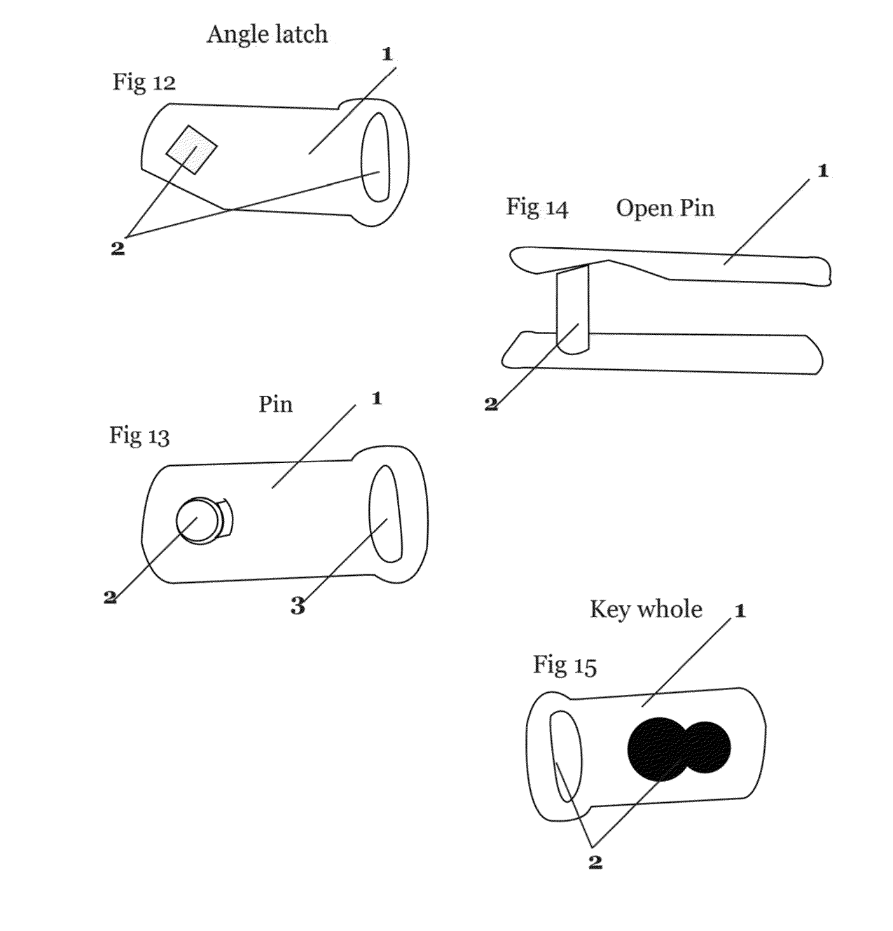

Photographs are attached for clearer understanding.

### DETAILED DESCRIPTION ON THE DRAWINGS

FIG. 10 is a complete drawing in reference to the tailgate adjustable Ex support system installed in the open position of the Pickup truck.

1. The pickup truck

2. Pickup truck tailgate

3. Pickup truck bed

4. Original latching system

5. Original Pin

6. Original OEM cables

7. Adjustable tailgate Ex Support System

8. Angle latch, Pin and Open pin

9. Slip Hook and Key Hole

FIG. 11 is a complete drawing in reference to the tailgate adjustable Ex support system demonstrating the adjustment process.

1. Pickup truck

2. Adjustable tailgate Ex support system in working position.

3. Tailgate showing multiple positions.

FIG. 12 is a drawing of the Angle Latch, stamped out of metal and punched openings.

FIG. 13 is a drawing of the Pin, stamped out of metal with a welded pin and a punched opening.

FIG. 14 is a drawing of the Open Pin, stamped metal 2 plated with a welded pin on both sides of the pin.

FIG. 15 is a drawing of the Keyhole, stamped metal with punched openings.

What is claimed is:

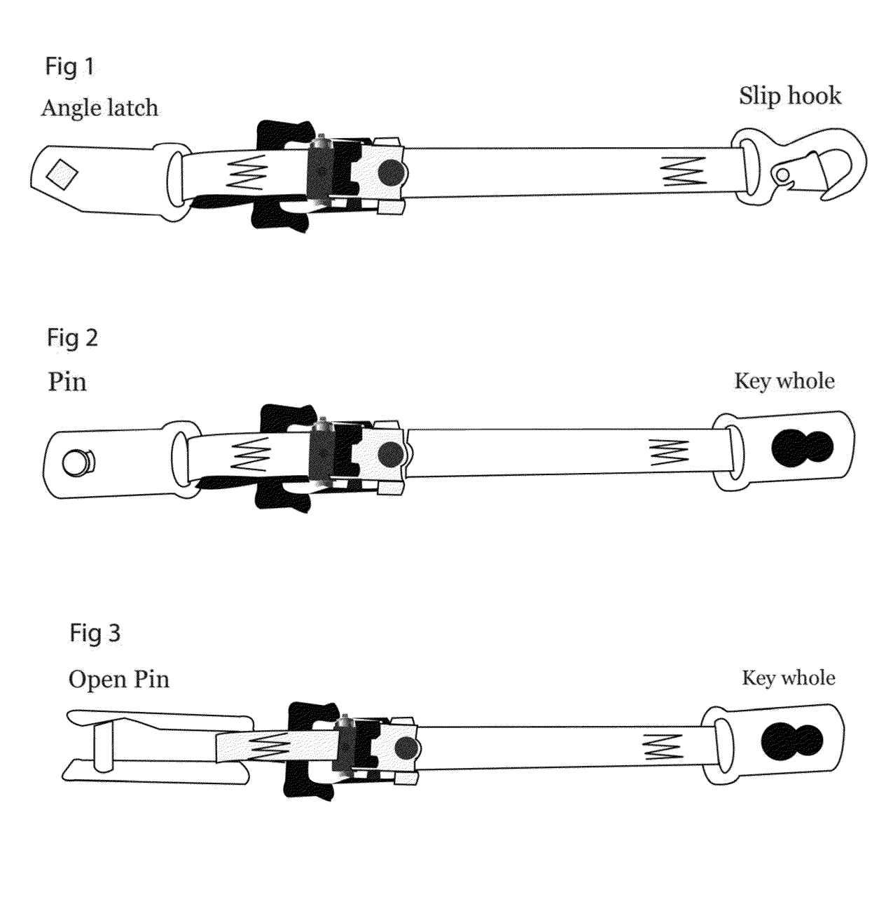

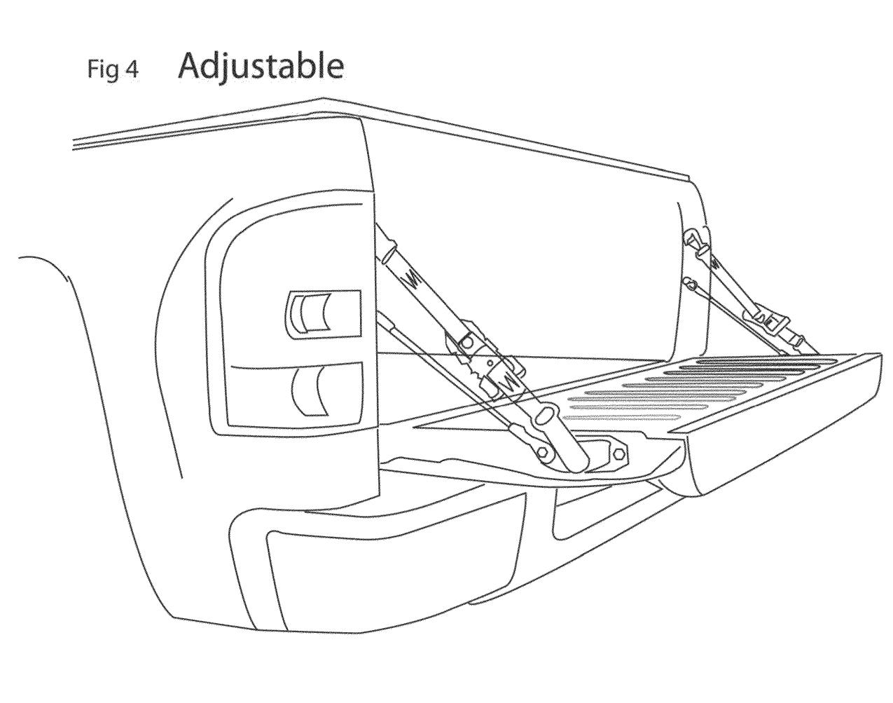

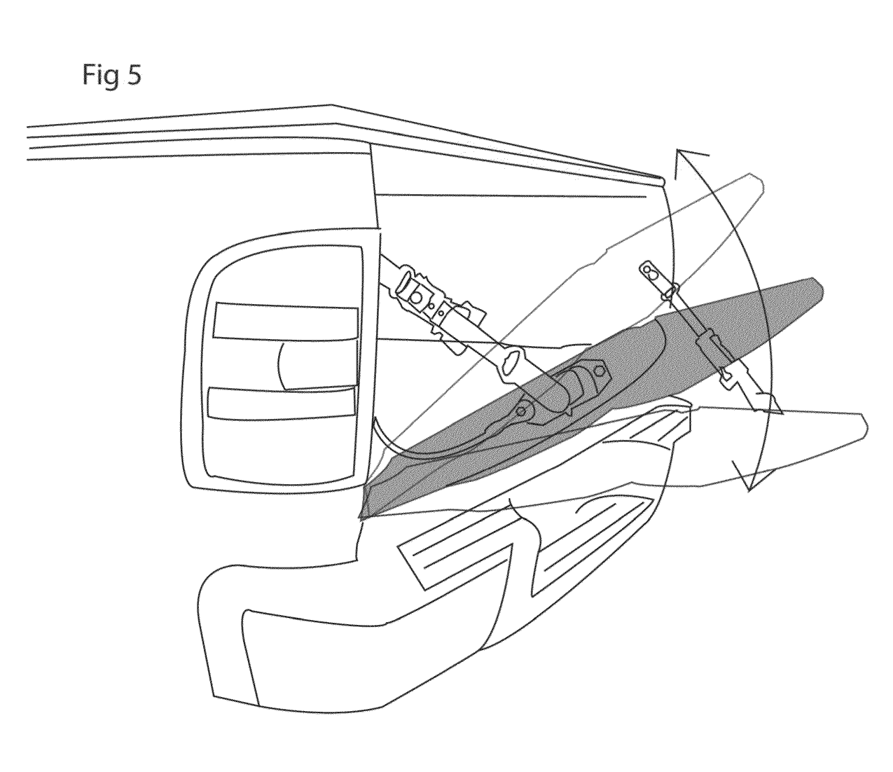

1. The tailgate adjustable EX support as a complete assembly and is for securing the tailgate in an open position and or multiple positions. With end 1) to fit into the latching system already established from the manufacture, the Angled latch, Pin, Open Pin and end 2) to hook onto and or loop over the pin already established from the manufacture keyhole.
Tailgate adjustable EX support and stable cable system gives extra support to the pickup truck tailgate. FIGS. 1, 2 and 3 showing each latching end 1 and end 2 as a complete assembly with each end 1 and end 2. FIG. 4 shows the tailgate adjustable Ex support in the open position installed. FIG. 5 showing the adjustable options available by utilizing the adjustable ratchet system.)

2. Utilizing already manufacture products and our products make up the tailgate adjustable EX support and stable cable system. Ready manufactured products for our tailgate adjustable EX support and stable cable system are nylon fabric straps and manufactured ratcheting mechanisms End 1 and end 2 are our manufactured products and manufactured for perfect fit into the latching system of the already manufactured tailgate latching system. Hook and loop end 2 has One of our products with a keyhole and another manufactured end 2 slip hook.)

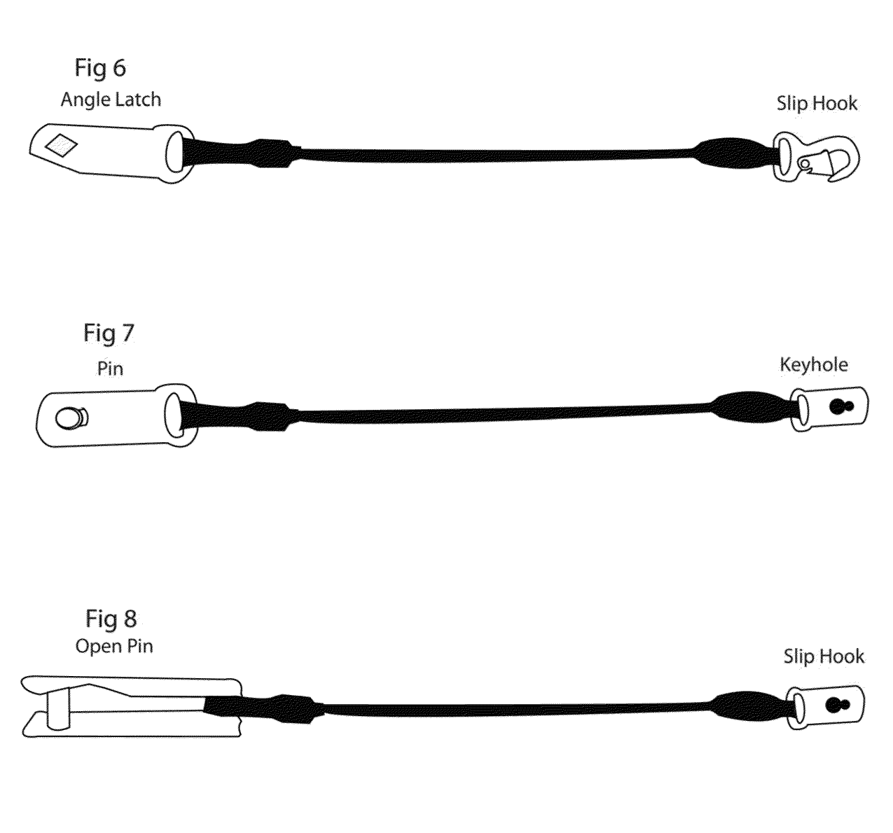

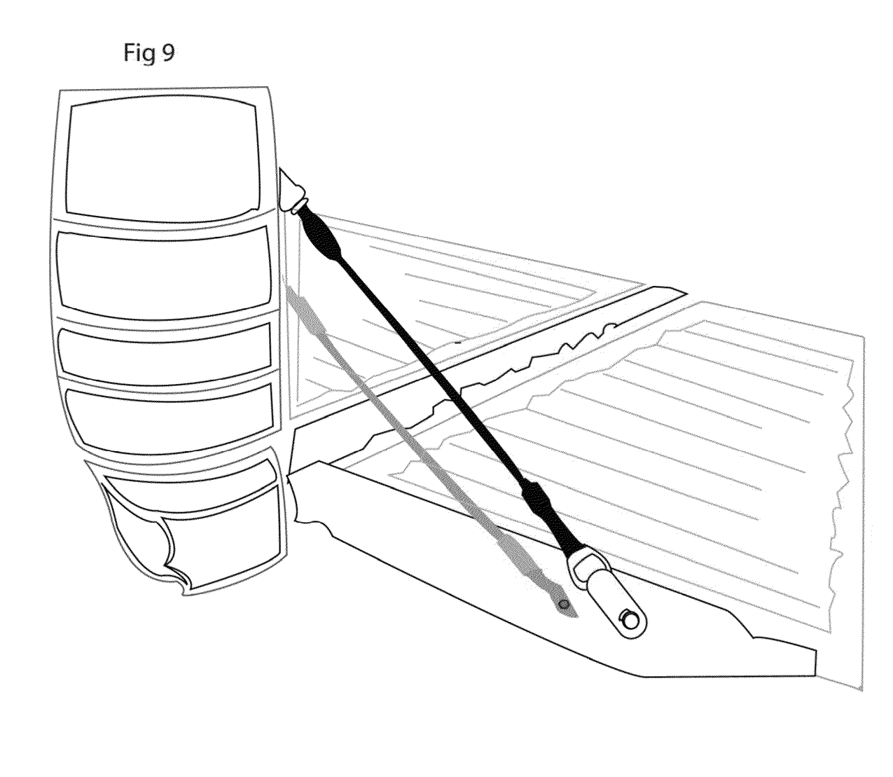

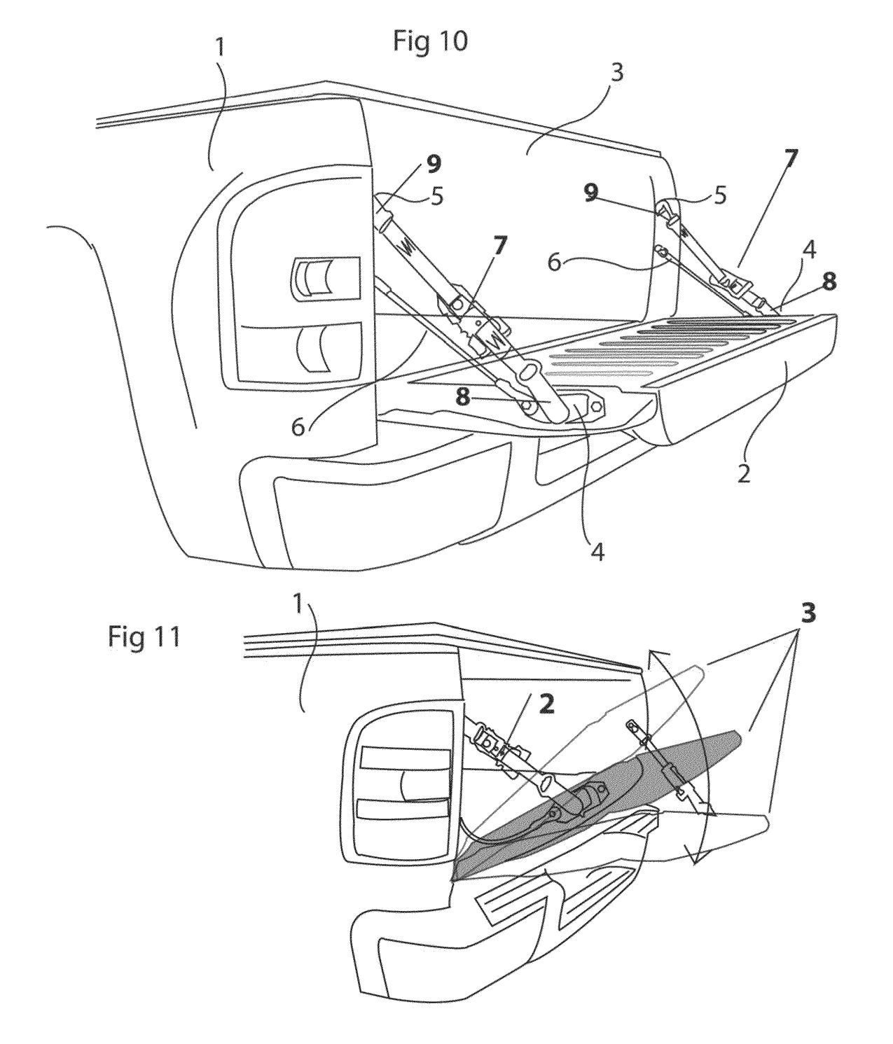

3. Tailgate stable cable system as a complete assembly is the same idea and only in an open position, end 1 and end 2 are our products utilizing the same format as the tailgate adjustable EX support system. Now utilizing manufactured cables for an alternative way to support you tailgate in an open position. FIGS. 6, 7 and 8 showing the stable cable system with end 1 and end 2 being the (Angle latch, pin, Open pin, Keyhole) our products and the slip hook manufactured product.)

4. Tailgate adjustable Ex Support as in claim 1.) Our end 1) Angle latch, a Pin and Open pin made with metal and not limited to metal, to fit a variety of pickup truck latching systems.
a) The Tailgate adjustable Ex support as in claim 2.) Utilizing already manufactured products with end 2) a keyhole made out of metal and not limited to metal slips over the already manufactured pin to complete the tailgate adjustable system.
b) Stable Cable System utilizing the same end 1) and end 2) attached to a strong already made cable from a manufacture is a compete assembly for the tailgate to be EX support for the tailgate in the open position only.
